(19) United States
(12) Patent Application Publication
(10) Pub. No.: US 2014/0377731 A1
(43) Pub. Date: Dec. 25, 2014

(54) Test Platform for Wrist-Mounted Physiologic Measurement Device

(71) Applicant: Google Inc., Mountain View, CA (US)

(72) Inventors: Andrew Conrad, Mountain View, CA (US); Eric Peeters, Mountain View, CA (US)

(21) Appl. No.: 13/924,246

(22) Filed: Jun. 21, 2013

(51) Int. Cl. G09B 23/30

(52) U.S. Cl. CPC G09B 23/303
USPC 434/268

(57) ABSTRACT

A test model has an outer polymer layer that models an exterior surface of a human arm and includes at least a wrist portion, an inner polymer core that is at least partially surrounded by the outer polymer layer and extends into the wrist portion, and polymer tubing adjacent to the inner polymer core. The polymer tubing is at least partially surrounded by the outer polymer layer and extends into the wrist portion. The polymer tubing has a first fluid inlet and a first fluid outlet. The test model is substantially free of metallic and magnetic materials.

### BACKGROUND

A number of scientific methods have been developed in the medical field to measure physiological conditions of a person. For example, devices exist that may be used to measure physiological conditions such as a user's heart rate, blood pressure, skin temperature, breathing rate, etc.

Additional physiological parameters may be obtained by measuring one or more analytes in a person's blood. The one or more analytes could be any analytes that, when present in the blood at a particular concentration or range of concentrations, may be indicative of a medical condition or health of the person. The one or more analytes could include enzymes, hormones, proteins, cells, or other molecules.

In a typical scenario, a person's blood is drawn and sent to a lab where a variety of tests are performed to measure various analyte levels and parameters in the blood. The variety of tests may be referred to as “blood work,” where the blood is tested for the presence of various diseases, or analyte levels such as cholesterol levels, etc. For most people, the blood tests are infrequent, and an abnormal analyte level indicative of a medical condition may not be identified until the next blood test is performed.

Even in the case of relatively frequent blood testing, such as may be found with those with diabetes, who regularly draw blood to test for blood glucose concentrations, those blood tests are typically performed when the user is awake, although the blood glucose levels (and potential variations in such levels) occurring during the night could provide important information to assist a physician in assessing that person's medical condition.

### SUMMARY

In one aspect, example embodiments relate to a test model having an outer polymer layer and an inner polymer core. The outer polymer layer models an exterior surface of a human arm and includes at least a wrist portion. The inner polymer core is at least partially surrounded by the outer polymer layer and extends into the wrist portion. A first polymer tubing is positioned over the inner polymer core, is at least partially surrounded by the outer polymer layer, and extends into the wrist portion. The first polymer tubing defines a first fluid inlet and a first fluid outlet. The test model is substantially free of metallic and magnetic materials.

In another aspect, example embodiments relate to a method in which an inner polymer core is formed in a first mold, a first polymer tubing defining at least one fluid inlet and at least one fluid outlet is positioned over the inner polymer core, the inner polymer core with the first polymer tubing is placed in a second mold, and an outer polymer layer is formed in the second mold such that the outer polymer layer at least partially surrounds the inner polymer core and first polymer tubing. The inner polymer core is more rigid that the outer polymer layer. The outer polymer layer models an exterior surface of a human arm and includes at least a wrist portion. The first polymer tubing extends into the wrist portion.

In yet another aspect, example embodiments relate to a method in which a first wearable device is mounted to a wrist portion of a test model. The test model has an outer polymer layer that models an exterior surface of a human arm and includes at least a wrist portion and an inner polymer core that is at least partially surrounded by the outer polymer layer and extends into the wrist portion. The test model also includes a first polymer tubing that is adjacent to the inner polymer core, at least partially surrounded by the outer polymer layer, extends into the wrist portion, and has a first fluid inlet and a first fluid outlet. The test model is substantially free of metallic and magnetic materials. In the method, the first fluid inlet is connected to a pump, a fluid containing particles is pumped through the polymer tubing, and the fluid in the first polymer tubing is non-invasively interrogated using the wearable device mounted to the wrist portion of the test model.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a perspective view of test platform 10 showing the palm 18 of the hand facing upwards, according to an example embodiment.

FIG. 2 is a perspective view of test platform 10 of FIG. 1 showing the back of the hand 20, according to an example embodiment.

FIG. 3 is a perspective view of the rear 36 of test platform 10 shown in FIGS. 1 and 2 showing tubes extending into and out of test platform 10, according to an example embodiment.

FIG. 4 is another perspective view of the rear 36 of test platform 10 shown in FIGS. 1-3 showing the orientation of tubes extending into and out of test platform 10, according to an example embodiment.

FIG. 5 is a perspective view of inner polymer core 40 that is positioned within the test platform 10 shown in FIGS. 1-4, according to an example embodiment.

FIG. 6A shows a perspective view of inner polymer core 40 shown in FIG. 5 with polymer tubing 30 and 32 positioned thereon, according to an example embodiment.

FIG. 6B shows a perspective view of the inner polymer core 40 and polymer tubing 30 and 32 shown in FIG. 6A with a dotted outline showing test model 10 of FIGS. 1-4, according to an example embodiment.

FIG. 7A shows a perspective view of inner polymer core 40 shown in FIG. 5 with polymer tubing 80 positioned thereon, according to an example embodiment.

FIG. 7B shows a perspective view of the inner polymer core 40 and polymer tubing 80 shown in FIG. 7A with a dotted outline showing test model 10 of FIGS. 1-4, according to an example embodiment.

FIG. 8 shows a cross-sectional view of a test model having tubes 30 and 32 positioned parallel to an exterior surface of the test model, according to an example embodiment.

FIG. 9A shows another cross-sectional view of a test model having tubes 30 and 32 extending at an angle within the test model, according to an example embodiment.

FIG. 9B shows non-invasive blood interrogation device 90 mounted to the wrist portion of the test model shown in FIG. 9A in one location, and another non-invasive blood interrogation device 90 mounted to the test model in another location, according to an example embodiment.

FIG. 10 is a perspective view showing tubes 50 and 52 positioned within a test model where the inner polymer core and outer polymer layer are shown in dotted lines, according to an example embodiment.

FIG. 11 is a perspective view showing tubes 60, 62, and 64 positioned within a test model where the inner polymer core and outer polymer layer are shown in dotted lines, according to an example embodiment.

FIG. 12 is a perspective view showing tube 70 positioned within a test model where the inner polymer core and outer polymer layer are shown in dotted lines, according to an example embodiment.

FIG. 13 is a flow chart of a method, according to an example embodiment.

FIG. 14 is a flow chart of a method, according to an example embodiment.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed devices and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

To measure analytes in blood non-invasively, particles may be introduced into a person's bloodstream, for example, by injection, ingestion, inhalation, transdermally, or in some other manner. The particles could be either magnetic (e.g., ferromagnetic or paramagnetic) or non-magnetic. The particles could be nanoparticles or microparticles with diameters less than about 20 microns (e.g., in the range of 10 nanometers to 2000 nanometers). The particles can be functionalized by covalently attaching an antibody, peptide, nucleic acid, or other molecule that specifically binds to or otherwise recognizes a particular analyte.

A number of techniques or modalities may be used to non-invasively analyze the particles introduced into a user's blood. As examples, magnetic, optical, luminescence, Hall Effect, and acoustic interrogation techniques may be used. The forearm, wrist, and hand of a person may be useful places to perform non-invasive interrogation of the person's blood because the veins of the person are often at or near the surface of the skin in these locations.

A non-invasive blood interrogation device that periodically performs measurements on a user's blood could be worn on the user's forearm, wrist, hand, or other body part. The wrist can be advantageous, as there are often veins near the surface of the skin, sometimes appearing on both sides of the wrist. Moreover, many people are accustomed to wearing a wristwatch and may easily adapt to wearing a wrist-mounted non-invasive blood interrogation device. It is contemplated that the blood interrogation device could be worn by the user on a continuous basis so that analyte measurements could be conducted on a regular, frequent basis.

During each measurement period, a wrist-mounted device may activate a magnet that directs a magnetic field into the subsurface vasculature proximate to the wrist-mounted device. The magnetic field is sufficient to cause functionalized magnetic nanoparticles to collect in the subsurface vasculature proximate to the wrist-mounted device. The wrist-mounted device may then direct an interrogating signal into the subsurface vasculature proximate the wrist-mounted device and detect a response signal transmitted from the subsurface vasculature proximate to the wrist-mounted device in response to the interrogating signal.

The interrogating signal can be any kind of signal that is benign to the wearer and results in a response signal that can be used to detect binding of the one or more analytes to the functionalized particles. In one example, the interrogating signal is an electromagnetic pulse (e.g., radio frequency (RF) pulse) and the response signal is a nuclear magnetic resonance (NMR) signal. In another example, the functionalized particles include a fluorophore, the interrogating signal is an optical signal with a wavelength that can excite the fluorophore and penetrate the skin and subsurface vasculature (e.g., a wavelength in the range of about 500 to about 1000 nanometers), and the response signal is fluorescence radiation from the fluorophore that can penetrate the subsurface vasculature and skin to reach the detector.

It may be desirable to optimize the testing based on the particular measurement that is being conducted. However, there a number of variables that may be changed during the testing, including the duration and frequency of the testing, the type, size, and concentration of the particles being used, as well as the particular blood interrogation technique selected, whether it be magnetic, optical, acoustical, luminescence, Hall Effect, thermal, or some other technique. Therefore, it is apparent that a great deal of testing may be required to determine the optimal test parameters when measuring for a particular analyte.

In addition, depending on the particular analyte that is being measured, the optimized test parameters and interrogation technique or modality may not be optimal for measuring a different analyte. Thus, a separate set of testing may be required to determine the optimal parameters for the each analyte to be tested.

Compounding the matter is that the blood and vasculature characteristics of each person may be very different. For example, individuals may have varying blood pressures, blood viscosity, blood flow rates, blood types, etc. which could have an effect on the determining the optimal test parameters.

Furthermore, individuals may have veins of varied thickness and width, and some may have veins positioned at or near the surface of the skin, and others may have veins that are located more deeply beneath the skin. Such varied parameters may also affect the determining the optimal test parameters.

Therefore, it will be appreciated that a significant amount of testing may be required to determine optimal test parameters for each analyte, taking into account the interrogation technique used and the individual blood and vascular characteristics of the individual to be tested. It will also be appreciated that the extensive testing that may be required could be very costly and time-consuming to perform on live humans.

As a result, the present embodiments provide a test platform for a physiological measurement device that may be mounted to a user's forearm, wrist, or hand. The test platform may be used to conduct the extensive testing that may be required, in lieu of or in addition to testing on live humans. A particular test platform may be configured based on the specific physiological characteristic or characteristics that would be measured using the physiological measurement device as well as the specific detection modality (magnetic, optical, acoustic, thermal, etc.) that would be used. Thus, many versions of the test platform are possible.

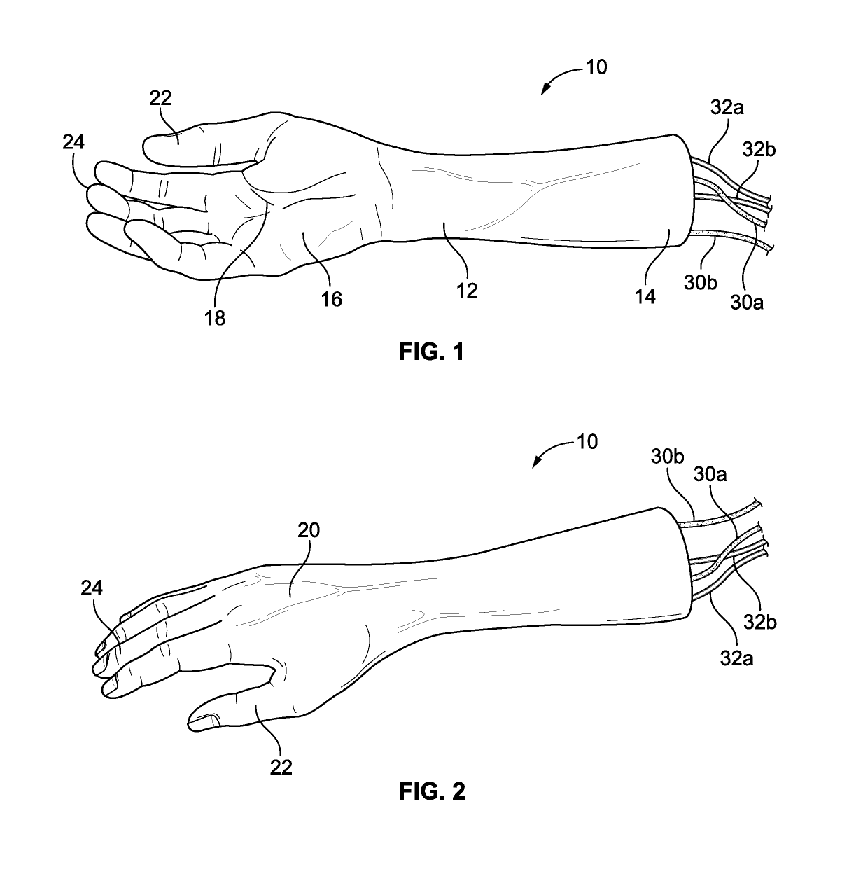

As shown in FIG. 1, the test platform 10 may be configured in the shape of a human arm and include simulated vasculature to allow testing of non-invasive means for interrogating subsurface vasculature in the forearm, wrist, or hand. In one example, the test platform 10 is substantially free of metallic and magnetic materials and includes an outer polymer layer, an inner polymer core, and polymer tubing.

The outer polymer layer models an exterior surface of a human arm and may include a forearm portion 14, a wrist portion 12, a hand portion 16, and even finger portions such as finger 24. The outer polymer layer can be made of a polymeric material, such as silicone, having a flexibility similar to that of human flesh.

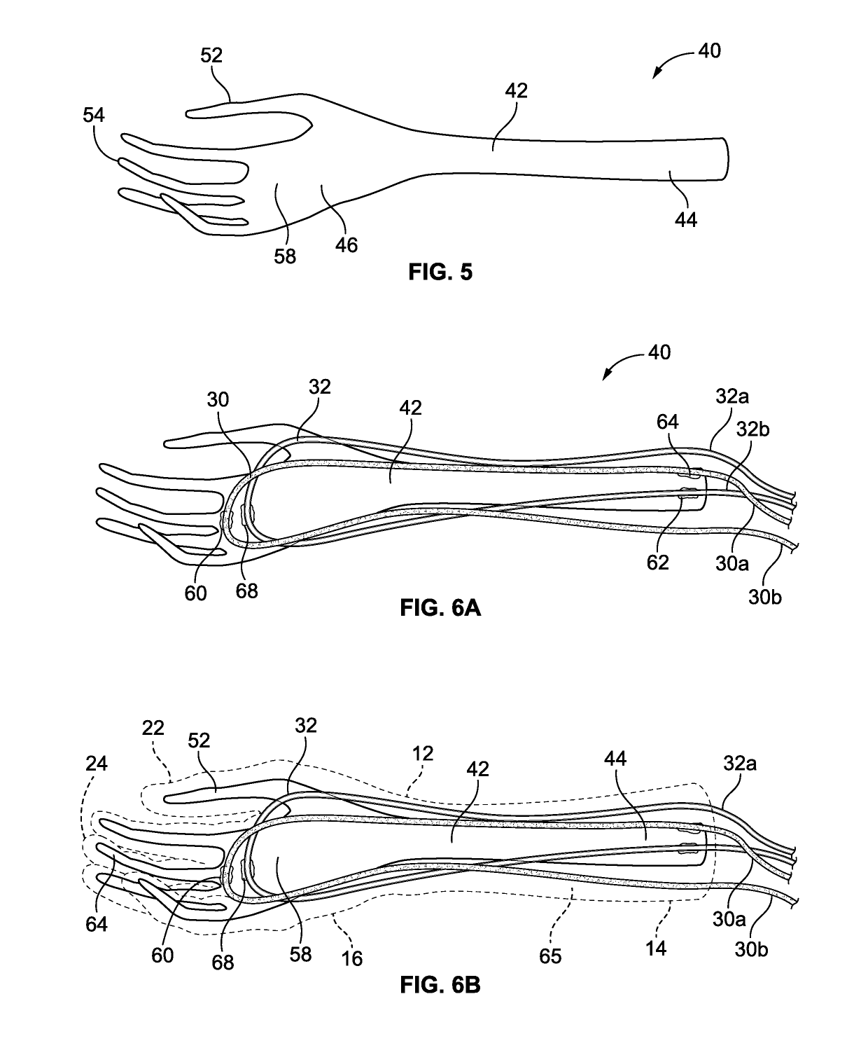

The inner polymer core 40 (shown in FIGS. 5, 6A, and 6B) is at least partially surrounded by the outer polymer layer and may extend into the forearm portion 14, wrist portion 12, hand portion 16, and even finger portions, such as finger 24 or thumb 22 of the test model 10. The inner polymer core 40 is more rigid than the outer polymer layer, so as to simulate bone structure. In one example, the inner polymer core 40 is made of polycarbonate and/or polyethylene.

Polymer tubing, such as polymer tubing 30 and 32 (shown in FIGS. 6A and 6B), may be used to simulate vasculature, and provide a circulatory system within the test model 10. The polymer tubing 30 and 32 may extend into at least the forearm portion 14 and the wrist portion 12 of the test model 10 and may be at least partially surrounded by the outer polymer layer. As shown in FIGS. 1-4, the polymer tubing 30 defines a first fluid inlet 30a and a first fluid outlet 30b that can be connected to a pump. A pump can be connected to fluid inlet 30a and can be used to pump a fluid, such as blood, through the polymer tubing 30 where the fluid flows through the forearm portion 14, wrist portion 12, and hand portion 16 of test model 10 and exits the test model at fluid outlet 30b.

Similarly, polymer tubing 32 defines a second fluid inlet 32a and a second fluid outlet 32b that can be connected to a pump. A pump can be connected to fluid inlet 32a and can be used to pump a fluid, such as blood, through the polymer tubing 32 where the fluid flows through the forearm portion 14, wrist portion 12, and hand portion 16 of test model 10 and exits the test model at fluid outlet 32b. The pump could be a peristaltic pump or a pulse pump to simulate blood flow within a person. In addition to polymer tubing 30 and 32, vasculature (e.g. superficial vasculature) could be simulated by the outer polymer layer, the inner polymer core, and/or by another component of test platform 10.

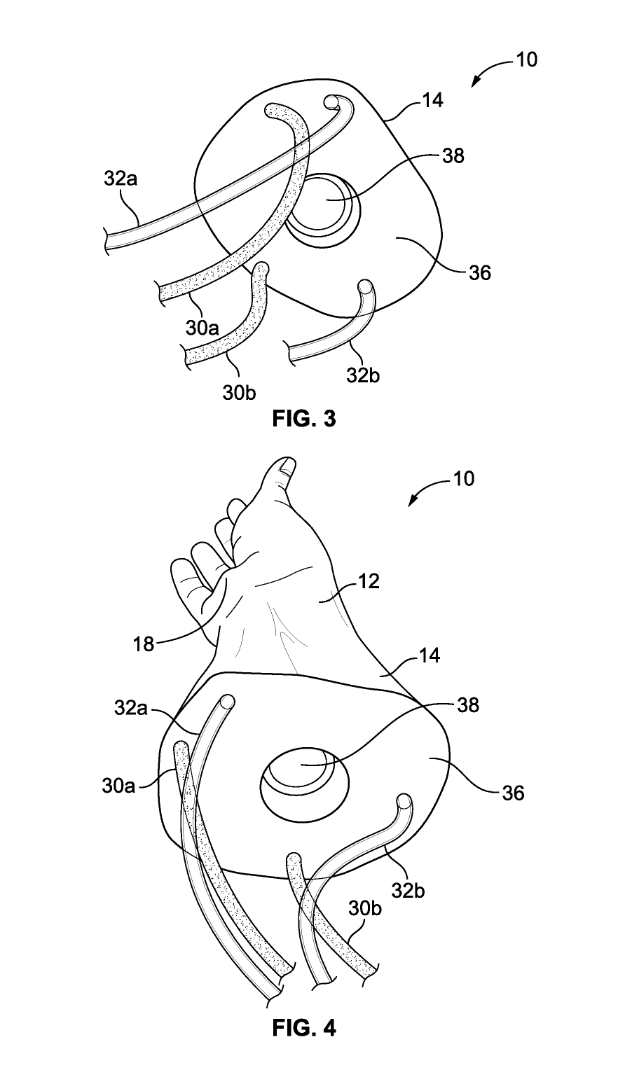

FIG. 1 is a perspective view of test platform 10 showing the palm 18 of the hand facing upwards, according to an example embodiment, and FIG. 2 is a perspective view of test platform 10 of FIG. 1 showing the back of the hand 20. FIGS. 3 and 4 are perspective views of the rear 36 of test platform 10 shown in FIGS. 1 and 2 showing fluid inlet 30a of tube 30 entering the test model and fluid outlet 30b exiting the test model, as well as fluid inlet 32a of tube 32 entering the test model and fluid outlet 32b exiting the test model.

In one example, there are two polymer tubes, each with a respective portion proximate an exterior surface of the wrist portion 12 of the test platform 10 and a respective portion located deeper within the test platform 10. Varying the depth of the tubes within the test platform allows for testing of the various blood interrogation techniques at various depths within the test model. As a result, this test platform provides the versatility to allow the blood interrogation device to conduct testing at various vein depths that may be found in the different patients that are encountered.

Although FIGS. 1-4 show an example test platform that models a human arm with a forearm portion, a wrist portion, a hand portion, and finger portions, it is to be understood that other test platforms could include fewer or additional portions. Thus, a test platform might include a forearm portion and a wrist portion but without hand and finger portions, or a test platform might include an upper arm portion in addition to a forearm portion. In other examples, a test platform may model a body part other than an arm, such as a leg, thigh, ankle, foot, shoulder, etc. In still other examples, the test platform may include internal tubing to model vasculature without modeling an external appearance of a body part. Other examples are possible as well.

The test platform 10 can be fabricated in a two-step molding process. In this process, the inner polymer core 40 shown in FIG. 5 is formed in a first mold. The inner polymer core 40 may include a forearm portion 44, a wrist portion 42, and a hand portion 46 with palm 58. The inner polymer core 40 may also include a finger portion, such as finger 54 and thumb 52, if desired. The inner polymer core 40 is a rigid structure that may simulate bone within a person's arm, and may be made of polycarbonate and/or polyethylene, as examples. The inner polymer core should be free of magnetic and metallic particles that could have an undesirable impact on the various blood interrogation techniques contemplated.

In the next step, as shown in FIG. 6A, the polymer tubing 30 and 32 is positioned over the inner polymer core 40. The polymer tubing 30 and 32 may be carefully positioned over or adjacent to the inner polymer core 40 and held in place with putty so that the tubing is properly positioned in a desired location that will result in the tubing placed at a desired depth within the test model 10.

Once the polymer tubing 30 and 32 is properly positioned over the inner polymer core 40, the next step in the process is placing the inner polymer core 40 and polymer tubing 30 and 32 in a second mold. The outer polymer layer is introduced into the mold and formed in the second mold, as shown in FIG. 6B so as to at least partially surround the inner polymer core 40 and the polymer tubing 30 and 32. With this molding process, the polymer tubing 30 and 32 may be precisely positioned at a desired depth within the test model 10 at various locations within the test model 10.

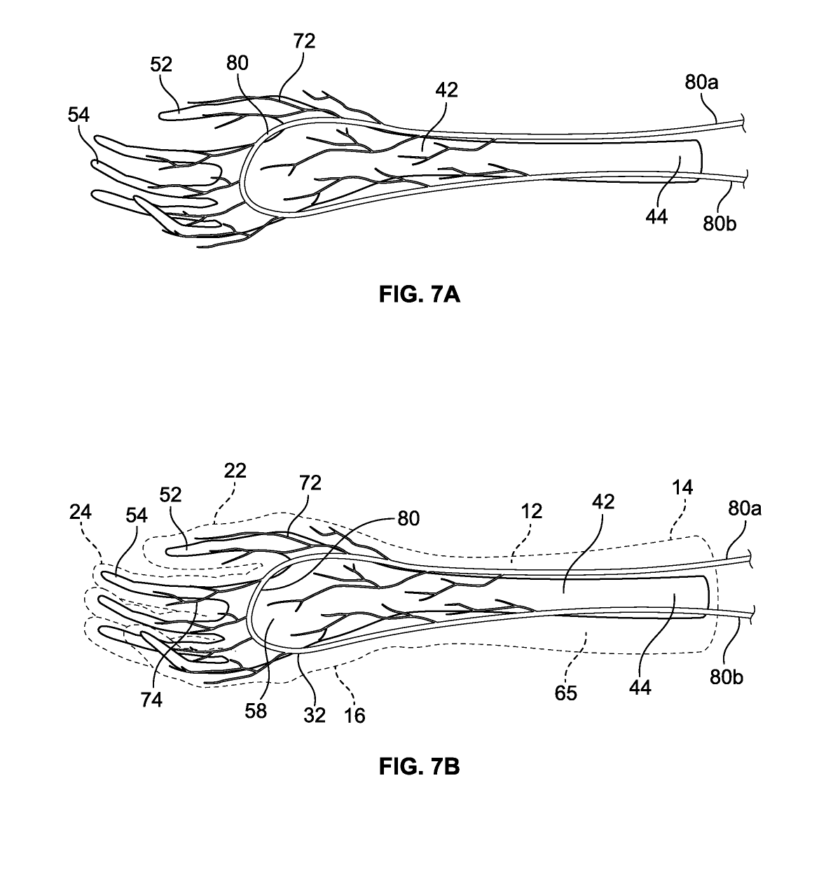

In some applications, it may desirable for the test platform to replicate a capillary web within the arm. As shown in FIG. 7A, a polymer tubing 80 may be positioned over inner polymer core 40, where the polymer tubing 80 includes a fluid inlet 80a and a fluid outlet 80b.

In FIG. 7A, a capillary web 72 is shown extending from polymer tubing 80. FIG. 7B, shows polymer tube 80 and capillary web 72 after the second molding operation, where the outer polymer layer has been introduced into the mold and formed in the second mold so as to at least partially surround the inner polymer core 40 and the polymer tubing 80 and capillary web 72.

The test platform can be used to test various techniques for non-invasively interrogating blood circulating in the vasculature of a human arm, in which the polymer tubing in the test platform simulates the vasculature. In one example, a wearable device is mounted to the wrist portion and a fluid (e.g., blood) containing magnetic particles is pumped through the polymer tubing. A magnet in the wearable device directs a magnetic field into the wrist portion. The magnetic field is sufficient to cause the magnetic particles to collect in the polymer tubing in the wrist portion.

A signal source in the wearable device directs an interrogating signal into the fluid in the polymer tubing in the wrist portion. A detector in the wearable device detects a response signal transmitted from the fluid in the polymer tubing in the wrist portion in response to the interrogating signal. The interrogating signal and response signal could be electromagnetic radiation, such as radio frequency (RF) radiation, a lower frequency magnetic field, infrared radiation, or visible light, as well as thermal, acoustic, and electric field. To test such signals, the materials of the outer polymer layer and polymer tubing can be selected so as to be substantially transparent to the electromagnetic radiation and magnetic fields.

The simulated vasculature system of the test platform may be advantageously used with a wide variety of testing parameters. For example, the same test platform may be used to conduct tests using different blood pressures, blood viscosities, blood flow rates, and pulse rates. Further, with a plurality of simulated veins in the test platform, the test platform may simultaneously conduct tests in one simulated vein using one set of test conditions and in another simulated vein using another set of test conditions. This versatility of the test platform allows for more testing to be conducted in a shorter period of time.

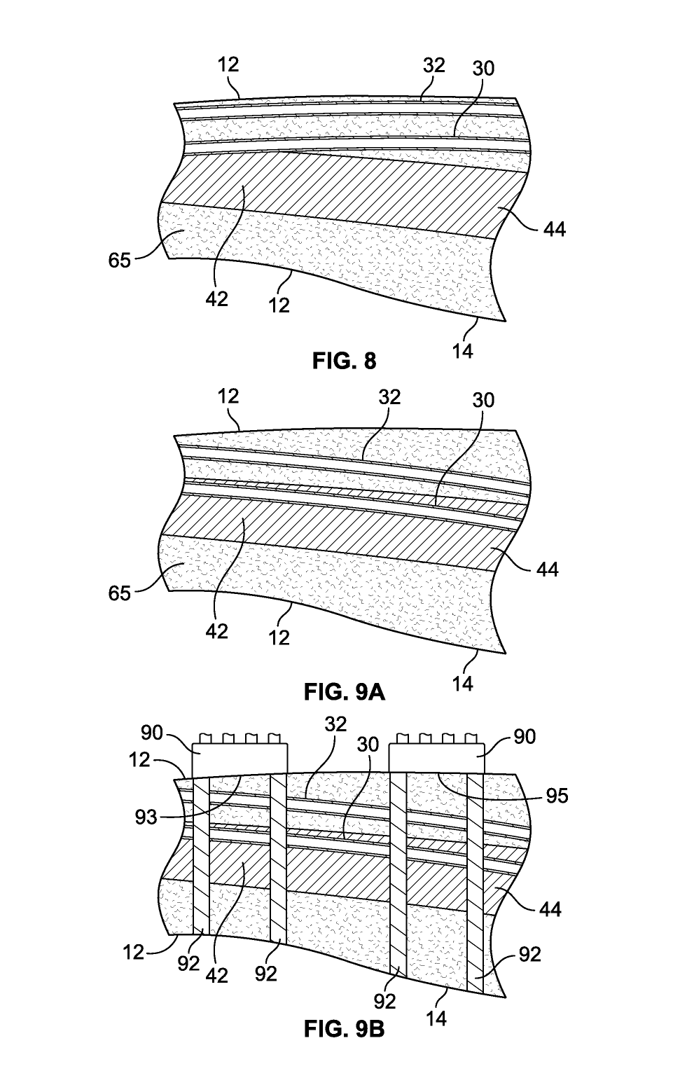

FIGS. 8 shows a first polymer tubing 30 located extending proximate to the surface of the test model 10. A second polymer tubing 32 is also shown extending parallel to the first polymer tubing 30, but at a depth further within the test model 10. With the polymer tubes 30 and 32 configured in this manner, the effect of the vein depth on a blood interrogation technique may be performed by having the same vascular parameters in terms of blood pressure, blood viscosity, blood flow rate, and pulse rate within both first polymer tubing 30 and second polymer tubing 32.

Of course, a first set of vascular parameters in terms of blood pressure, blood viscosity, blood flow rate, or pulse rate could be tested within the first polymer tubing 30, and a second and different set of vascular parameters in terms of blood pressure, blood viscosity, blood flow rate, or pulse rate could be tested within the second polymer tubing 32.

Similarly, the test platform may test for an array of different particles within the simulated vasculature at the same time. The particles may be varied in type, size, and concentration within a given fluid. A first set of particle parameters in terms of particle type, particle size, and particle concentration could be tested within the first polymer tubing 30, and a second and different set of particle parameters in terms of particle type, particle size, or particle concentration could be tested within the second polymer tubing 32, providing greater testing flexibility.

FIG. 9A shows a first polymer tubing 30 located extending at an angle within the test model 10. A second polymer tubing 32 is also shown extending at an angle within test model 10 and parallel to the first polymer tubing 30, but at a depth further within the test model 10. With the polymer tubes 30 and 32 configured in this manner, the effect of the vein depth on a blood interrogation technique may be performed by taking measurements at different locations having varied depths along the length of the first or second polymer tubing 30, 32.

For example, as shown in FIG. 9B, non-invasive blood interrogation device 90 may be positioned at a first location 93 on the wrist portion 12 held in place with straps 92, where the first and second polymer tubing 30, 32 are positioned at a first depth within the test model. Alternately, non-invasive blood interrogation device 90 may be positioned at a second location 95 on the wrist portion 12 held in place with straps 92, where the first and second polymer tubing 30, 32 are positioned a second depth, that is deeper within the test model than the first depth.

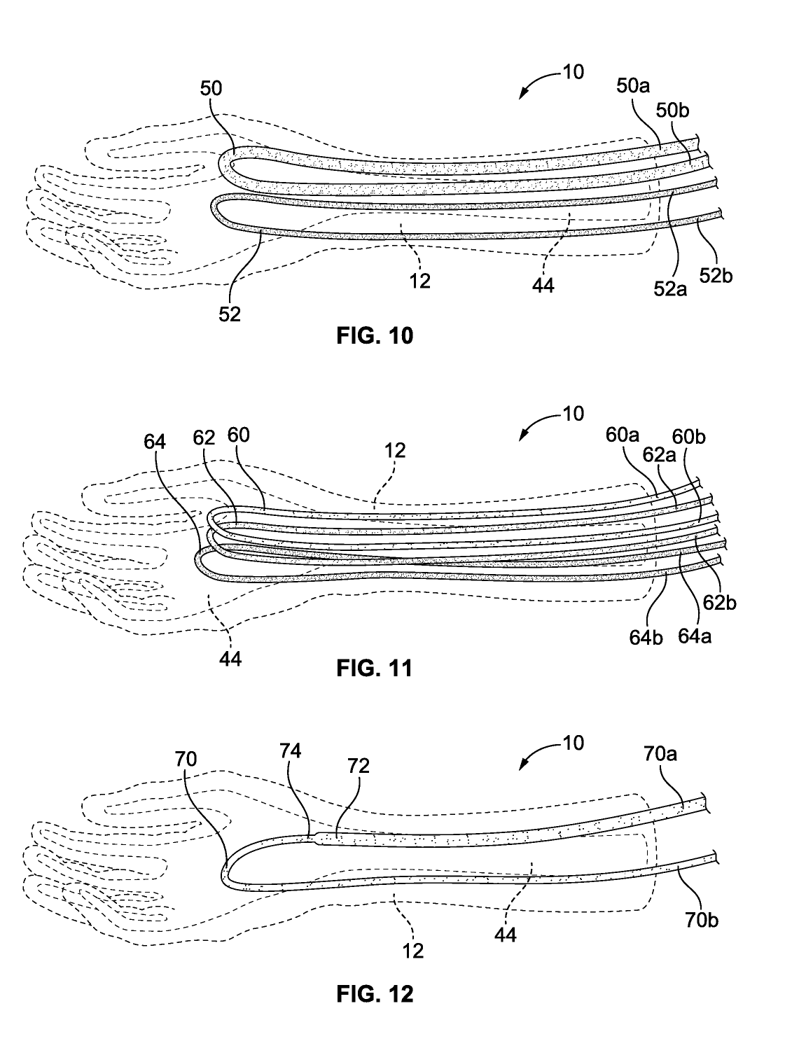

Furthermore, as show in FIG. 10, the test model 10 may have a first polymer tubing 50 with a first fluid inlet 50a extending into the test model 10 and a first fluid outlet 50b exiting from test model 10, as well as a second polymer tubing 52 with a first fluid inlet 52a extending into the test model 10 and a second fluid outlet 52b exiting from test model 10. In this configuration, the first polymer tubing 50 has a diameter that is greater than a diameter of the second polymer tubing 52 so that the effect of different vein diameters on the blood interrogation techniques may be tested.

As shown in FIG. 12, test model 10 includes polymer tubing 70 with a fluid inlet 70a extending into the test model 10 and a fluid outlet 70b exiting from test model 10. Polymer tubing 70 may have a first portion 72 having a first inner diameter that tapers down to a second, smaller inner diameter 74. With this configuration, the blood pressure and blood flow rate through the first portion 72 will differ from the blood pressure and blood flow rate through the second portion 74 of polymer tubing. Therefore, the effect of different blood pressure and different blood flow rate on a given blood interrogation technique may be tested. Furthermore, in some instances, the effect of stenoses or aneurysms could be tested if desired, by including simulations of them in the polymer tubing within the test model.

In addition, different interrogation techniques may be carried out on the same test platform. In fact, different interrogation techniques may be carried on the same test platform at the same time by mounting a plurality of blood interrogation devices on the test platform at the same time. In this example, the different blood interrogation techniques could be tested on the same simulated vein within the test model at the same time to insure that the fluid and vascular parameters are the same when comparing the effectiveness of the different blood interrogation techniques used on that simulated vein.

Furthermore, as shown in FIG. 11, the test model 10 may have a first polymer tubing 60 with a first fluid inlet 60a extending into the test model 10 and a first fluid outlet 60b exiting from test model 10, as well as a second polymer tubing 62 with a first fluid inlet 62a extending into the test model 10 and a second fluid outlet 62b exiting from test model 10, and also a third polymer tubing 64 with a first fluid inlet 64a extending into the test model 10 and a second fluid outlet 64b exiting from test model 10.

Each of first, second, and third polymer tubing 60, 62, and 64 may adapted for a particular blood interrogation technique. For example, polymer tubing 60 may be particularly well suited for magnetic blood interrogation, polymer tubing 62 may be translucent and particularly well suited for optical blood interrogation, and polymer tubing 64 may be well suited for a third blood interrogation technique, such as acoustic or ultrasonic blood interrogation. With this configuration, a number of different blood interrogation techniques may be advantageously be performed on the same test model.

Moreover, as discussed above with respect to FIGS. 9A and 9B, the simulated vasculature on a given platform may have the simulated vein positioned at different depths along the length of the hand, wrist, or forearm so that the testing of the various interrogation techniques may be performed with veins at varied depths beneath the surface of the arm of the test platform, providing for even greater testing versatility.

It will also be appreciated that a plurality of wrist-mounted blood interrogating devices could be used at the same time on the same test platform to further increase the testing capabilities of the test platform. For example, as shown in FIG. 9A, two non-invasive blood interrogation devices may be positioned at different locations on the wrist portion 12 of test model 10 at the same time. Further, a series of test platforms, using the same or different fluid parameters or vascular parameters, could be used to provide even more robust testing capabilities.

Additionally, the test platform may be configured so that the polymer tubing may be changed from test to test, if desired. For example, the polymer tubing could be “pulled through” the arm and wrist portion of the test platform by pulling a used section of polymer tubing through the test platform while advancing a new, unused section of polymer tubing and cutting off the old, used section. In this manner, a version of the test platform may be provided where the polymer tubing is disposable, to avoid cross-contamination between different experiments, as the particles and fluids may be difficult to clean out from the tubing completely. In other words, a new section of polymer tubing could be used for each test using the same test platform by replacing the polymer tubing used for each test.

A test platform using a polymer tubing that could be “pulled through” to allow a new section of tubing to be used for each test could be made by lubricating the outer surface of the polymer tubing prior to forming the outer polymer layer, or using a tubing with a high lubricity. With such lubricated tubing, a version of the test platform allowing for “pulled through” polymer tubing could be provided. Further, the outer surface of each new section of polymer tubing could be lubricated prior to advancing the new section into the test platform.

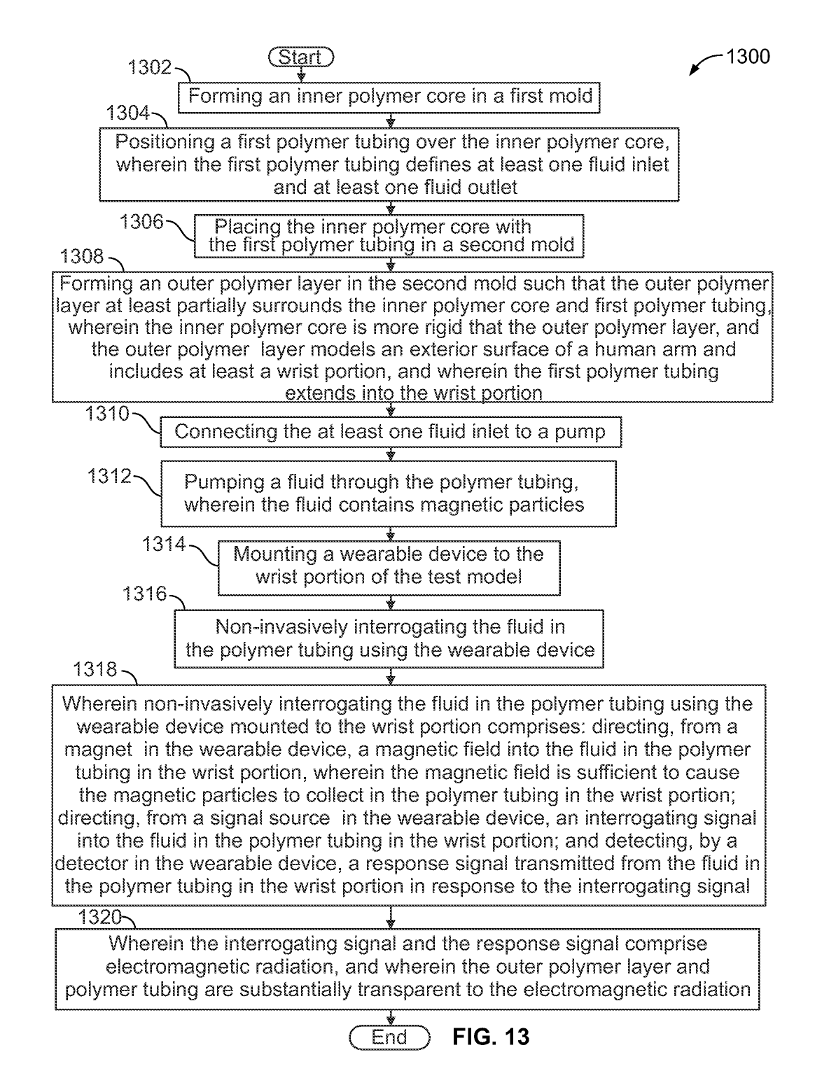

FIG. 13 is a flow chart illustrating a method 1300 that relates to fabricating and using a test model, such as any of the test models shown in FIGS. 1-12 and described above. As shown, method 1300 includes forming an inner polymer core in a first mold (step 1302), the positioning a first polymer tubing over the inner polymer core (step 1304), in which the first polymer tubing defines at least one fluid inlet and at least one fluid outlet, placing the inner polymer core with the first polymer tubing in a second mold (step 1306), and forming an outer polymer layer in the second mold such that the outer polymer layer at least partially surrounds the inner polymer core and first polymer tubing (step 1308). Further, the inner polymer core is more rigid than the outer polymer layer, the outer polymer layer models an exterior surface of a human arm and includes at least a wrist portion, and the first polymer tubing extends into the wrist portion.

Method 1300 may also include connecting the at least one fluid inlet to a pump (step 1310), and pumping a fluid containing magnetic particles through the polymer tubing (step 1312).

Method 1300 may further include mounting a wearable device to the wrist portion of the test model (step 1314), and non-invasively interrogating the fluid in the polymer tubing using the wearable device (step 1316). In some examples, non-invasively interrogating the fluid in the polymer tubing using the wearable device mounted to the wrist portion involves directing, from a magnet in the wearable device, a magnetic field into the fluid in the polymer tubing in the wrist portion, in which the magnetic field is sufficient to cause the magnetic particles to collect in the polymer tubing in the wrist portion, directing, from a signal source in the wearable device, an interrogating signal into the fluid in the polymer tubing in the wrist portion, and detecting, by a detector in the wearable device, a response signal transmitted from the fluid in the polymer tubing in the wrist portion in response to the interrogating signal (step 1318).

In some examples, the interrogating signal and the response signal comprise electromagnetic radiation, where the outer polymer layer and polymer tubing are substantially transparent to the electromagnetic radiation (step 1320).

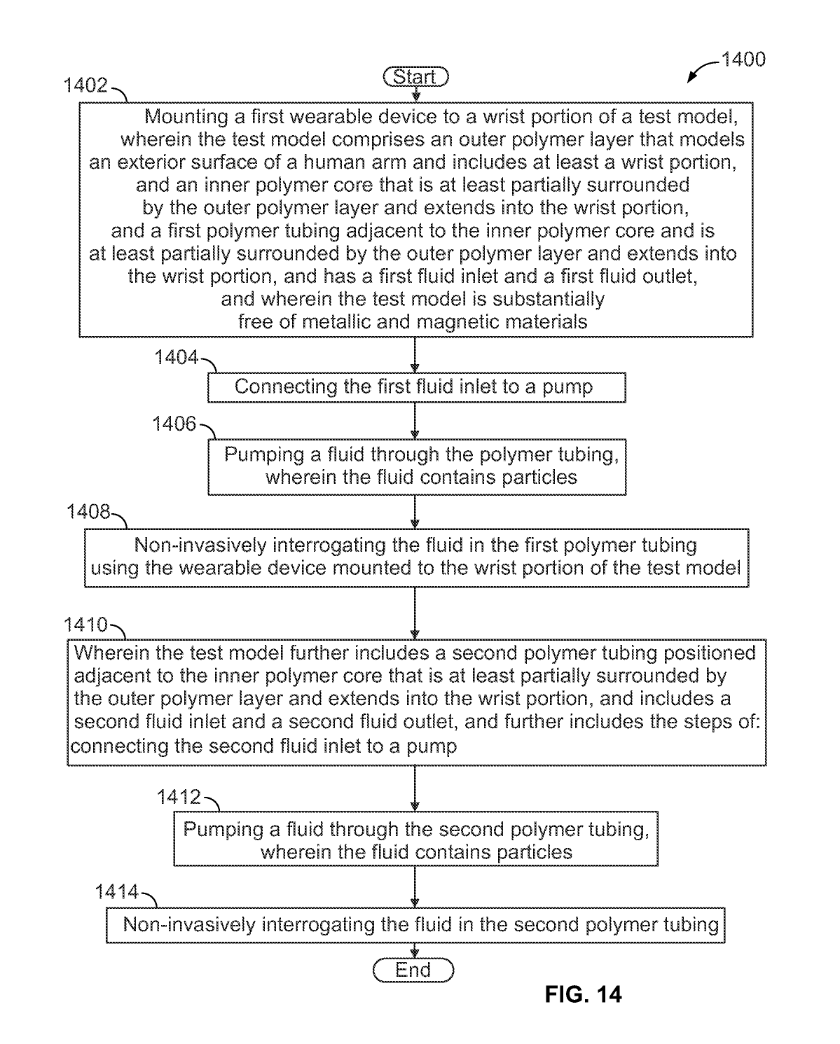

FIG. 14 is a flow chart illustrating a method 1400 that relates to using a test model, such as any of the test models shown in FIGS. 1-12 and described above. Method 1400 includes mounting a first wearable device to a wrist portion of a test model (step 1402). The test model includes an outer polymer layer that models an exterior surface of a human arm (e.g., at least a wrist portion), an inner polymer core that is at least partially surrounded by the outer polymer layer and extends into the wrist portion, and a first polymer tubing adjacent to the inner polymer core and is at least partially surrounded by the outer polymer layer and extends into the wrist portion. The first polymer tubing has a first fluid inlet and a first fluid outlet. The test model is substantially free of metallic and magnetic materials.

Method 1400 also includes connecting the first fluid inlet to a pump (step 1404), pumping a fluid containing particles through the polymer tubing (step 1406), and non-invasively interrogating the fluid in the first polymer tubing using the wearable device mounted to the wrist portion of the test model (step 1408).

In some examples, the test model includes a second polymer tubing positioned adjacent to the inner polymer core that is at least partially surrounded by the outer polymer layer and extends into the wrist portion, in which the second polymer tubing includes a second fluid inlet and a second fluid outlet. Thus, method 1400 may further include connecting the second fluid inlet to a pump (step 1410), pumping a fluid containing particles through the second polymer tubing (step 1412), and non-invasively interrogating the fluid in the second polymer tubing (step 1414).

It will be appreciated that the steps of method 1300 and method 1400 are listed in an order. However, unless one step is clearly required to follow a preceding step, the steps may be performed in any order.

Where example embodiments involve information related to a person or a device of a person, some embodiments may include privacy controls. Such privacy controls may include, at least, anonymization of device identifiers, transparency and user controls, including functionality that would enable users to modify or delete information relating to the user's use of a product.

Further, in situations in where embodiments discussed herein collect personal information about users, or may make use of personal information, the users may be provided with an opportunity to control whether programs or features collect user information (e.g., information about a user's medical history, social network, social actions or activities, profession, a user's preferences, or a user's current location) and an opportunity to control whether or how personal information is used. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and how the collected information is used.

The above detailed description describes various features and functions of the disclosed devices and methods with reference to the accompanying Figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A test model, comprising:
an outer polymer layer, wherein the outer polymer layer models an exterior surface of a human arm and includes at least a wrist portion;
an inner polymer core, wherein the inner polymer core is at least partially surrounded by the outer polymer layer and extends into the wrist portion to simulate superficial vasculature; and
a first polymer tubing positioned over the inner polymer core, wherein the polymer tubing is at least partially surrounded by the outer polymer layer and extends into the wrist portion, the polymer tubing defining a first fluid inlet and a first fluid outlet;
wherein the test model is substantially free of metallic and magnetic materials.

2. The test model of claim 1, wherein the inner polymer core is more rigid than the outer polymer layer.

3. The test model of claim 2, wherein the inner polymer core comprises at least one of polycarbonate or polyethylene, and wherein the outer polymer layer comprises silicone.

4. The test model of claim 1, further comprising a fluid disposed in the polymer tubing.

5. The test model of claim 4, wherein the fluid comprises blood.

6. The test model of claim 4, wherein the fluid contains magnetic particles.

7. The test model of claim 6, wherein the magnetic particles have an average size of 10 to 2000 nanometers.

8. The test model of claim 1, wherein the outer polymer layer is molded over the inner polymer core and the first polymer tubing.

9. The test model of claim 1, further comprising a second polymer tubing positioned over the inner polymer core, wherein the second polymer tubing is at least partially surrounded by the outer polymer layer and extends into the wrist portion, the second polymer tubing defining a second fluid inlet and a second fluid outlet.

10. The test model of claim 9, wherein the first and second polymer tubing each have a respective portion proximate an exterior surface of the wrist portion of the test model and a respective portion located deeper within the test model.

11. The test model of claim 9, wherein at a location on the wrist portion, the second polymer tubing is deeper within the test model than the first polymer tubing.

12. The test model of claim 9, wherein the first polymer tubing contains a first fluid, the second polymer tubing contains a second fluid, and the first fluid differs from the second fluid with respect to at least one of type of fluid, fluid pressure, fluid flow rate, or fluid viscosity.

13. The test model of claim 9, wherein a diameter of the second polymer tubing is different than a diameter of the first polymer tubing.

14. The test model of claim 9, wherein the first polymer tubing contains a fluid having particles therein and the second polymer tubing contains a fluid having particles therein.

15. The test model of claim 14, wherein the particles in the first polymer tubing differ from the particles in the second polymer tubing with respect to at least one of particle size, particle type, or particle concentration.

16. The test model of claim 9, further comprising a third polymer tubing positioned over the inner polymer core, wherein the third polymer tubing is at least partially surrounded by the outer polymer layer and extends into the wrist portion, the third polymer tubing defining a third fluid inlet and a third fluid outlet.

17. The test model of claim 1, wherein the first polymer tubing extends through the wrist portion at an angle so that a first portion of the first polymer tubing is positioned deeper within the test platform than a second portion of the first polymer tubing.

18. The test model of claim 1, wherein the first polymer tubing comprises a capillary web.

19. The test model of claim 1, wherein a first non-invasive fluid interrogating device is mounted to the wrist portion of the test model.

20. The test model of claim 19, wherein a second non-invasive fluid interrogating device is also mounted to the wrist portion or a forearm portion of the test model.

21. The test model of claim 1, further including a hand section that is articulable with respect to the wrist portion.

22. The test model of claim 1, wherein a first section of the polymer tubing within the outer polymer layer of the test model may be pulled through the outer polymer layer and replaced with a second section of polymer tubing advanced within the outer polymer layer of the test platform.

23. A method, comprising:
forming an inner polymer core in a first mold;
positioning a first polymer tubing over the inner polymer core, wherein the first polymer tubing defines at least one fluid inlet and at least one fluid outlet;
placing the inner polymer core with the first polymer tubing in a second mold; and
forming an outer polymer layer in the second mold such that the outer polymer layer at least partially surrounds the inner polymer core and first polymer tubing, wherein the inner polymer core is more rigid that the outer polymer layer, and the outer polymer layer models an exterior surface of a human arm and includes at least a wrist portion, and wherein the first polymer tubing extends into the wrist portion.

24. The method of claim 23, further comprising:
connecting the at least one fluid inlet to a pump; and
pumping a fluid through the polymer tubing, wherein the fluid contains magnetic particles.

25. The method of claim 24, further comprising:
mounting a wearable device to the wrist portion of the test model; and
non-invasively interrogating the fluid in the polymer tubing using the wearable device.

26. The method of claim 25, wherein non-invasively interrogating the fluid in the polymer tubing using the wearable device mounted to the wrist portion comprises:
directing, from a magnet in the wearable device, a magnetic field into the fluid in the polymer tubing in the wrist portion, wherein the magnetic field is sufficient to cause the magnetic particles to collect in the polymer tubing in the wrist portion;
directing, from a signal source in the wearable device, an interrogating signal into the fluid in the polymer tubing in the wrist portion; and
detecting, by a detector in the wearable device, a response signal transmitted from the fluid in the polymer tubing in the wrist portion in response to the interrogating signal.

27. The method of claim 26, wherein the interrogating signal and the response signal comprise electromagnetic radiation, and wherein the outer polymer layer and polymer tubing are substantially transparent to the electromagnetic radiation.

28. A method, comprising:
mounting a first wearable device to a wrist portion of a test model, wherein the test model comprises an outer polymer layer that models an exterior surface of a human arm and includes at least a wrist portion, and an inner polymer core that is at least partially surrounded by the outer polymer layer and extends into the wrist portion, and a first polymer tubing adjacent to the inner polymer core and is at least partially surrounded by the outer polymer layer and extends into the wrist portion, and has a first fluid inlet and a first fluid outlet, and wherein the test model is substantially free of metallic and magnetic materials;
connecting the first fluid inlet to a pump;
pumping a fluid through the polymer tubing, wherein the fluid contains particles; and
non-invasively interrogating the fluid in the first polymer tubing using the wearable device mounted to the wrist portion of the test model.

29. The method of claim 28, wherein the test model further includes a second polymer tubing positioned adjacent to the inner polymer core that is at least partially surrounded by the outer polymer layer and extends into the wrist portion, and includes a second fluid inlet and a second fluid outlet, and further includes the steps of:
connecting the second fluid inlet to a pump;
pumping a fluid through the second polymer tubing, wherein the fluid contains particles; and
non-invasively interrogating the fluid in the second polymer tubing.
